(19) United States
(12) Patent Application Publication
(10) Pub. No.: US 2025/0352835 A1
(43) Pub. Date: Nov. 20, 2025

(54) RESPIRATOR VALVE PROP APPARATUS

(71) Applicant: OHD, LLLP, Birmingham, AL (US)

(72) Inventors: Michael Hicks, Hoover, AL (US); Sean Simmons, Hoover, AL (US)

(73) Assignee: OHD, LLLP, Birmingham, AL (US)

(21) Appl. No.: 19/208,174

(22) Filed: May 14, 2025

Related U.S. Application Data
(60) Provisional application No. 63/647,479, filed on May 14, 2024.

(51) Int. Cl. A62B 27/00

(52) U.S. Cl. CPC A62B 27/00

(57) ABSTRACT

The present disclosure provides an apparatus and methods for opening a valve of a respirator for respirator fit testing. An apparatus may include: a platform connecting a first end to a second end; wherein the first end is configured to attach to an adapter of a respirator, wherein the adapter comprises a base having a cavity configured to receive the first end; wherein the second end comprises at least one protrusion extending from the platform; wherein the at least one protrusion comprises a length capable of extending into a valve in a respirator; and wherein the at least one protrusion is inserted into the valve to open the valve.

### CROSS-REFERENCE TO RELATED APPLICATION

This application claims the benefit of U.S. Provisional Application No. 63/647,479, filed May 14, 2024, entitled RESPIRATOR VALVE PROP APPARATUS.

### FIELD OF THE INVENTION

This disclosure generally relates to the field of respirators, and more particularly, devices and methods of opening a valve of a respirator for respirator fit testing.

### BACKGROUND

The use of respirators is required by several national and international standards, including the Occupational Safety and Health Administration (OSHA) in the United States when hazardous substances in the air cannot be controlled to an acceptable level for the health of employees. As a result, millions of individuals who may encounter inhalation hazards on the job rely on respirators.

According to OSHA, to ensure a respirator provides an appropriate level of protection, it is necessary that employers develop and maintain a respiratory protection program, of which respirator fit testing is a core concept. A respirator fit test evaluates the fit of a respirator to a wearer. A respirator fit test may ensure a respirator wearer is using an appropriate model, style, and size respirator, as tight-fitting respirators are necessary to avoid health concerns caused by the inhalation of contaminants due to poor seals, fittings, and other complications. Properly and tight-fitting respirators are necessary to avoid health concerns caused by the inhalation of contaminants due to poor seals, fittings, and other complications.

Fit testing may be performed qualitatively using a test agent detectable by the wearer, such as via the wearer's sense of taste, smell, or reaction to an irritant. Fit testing may also be performed quantitatively using an instrument to measure leakage of a test agent.

A majority of respirators have an exhalation valve that re-direct the user's breath during exhalation and an inhalation valve that opens when a user breathes to allow air to flow freely into the respirator through filters. It is important during respirator fit testing to prop at least one valve open to ensure continuous air flow during a fit test. If a valve is not propped open, the valve will close during testing, which will interfere with the negative pressure check used in some fit testing methods and the test will most likely fail or abort.

### BRIEF SUMMARY

The present disclosure provides an apparatus for opening a valve of a respirator for respirator fit testing including: a platform connecting a first end to a second end; wherein the first end is configured to attach to an adapter of a respirator, wherein the adapter comprises a base having a cavity configured to receive the first end; wherein the second end comprises at least one protrusion extending from the platform; wherein the at least one protrusion comprises a length capable of extending into the valve in the respirator; and wherein the at least one protrusion is inserted into the valve to open the valve.

The present disclosure provides a method of opening a valve of a respirator for respirator fit testing, the method including: obtaining an adapter for respirator fit testing, wherein the adapter comprises a base having a cavity; inserting an apparatus into the cavity of the base, wherein the apparatus comprises a platform having a first end and a second end, wherein the cavity is configured to receive the first end, wherein the second end comprises at least one protrusion extending from the platform, and wherein the at least one protrusion comprises a length configured to extend into a valve in a respirator; attaching the adapter to the respirator, wherein attaching the adapter to the respirator comprises applying a pressure, wherein the apparatus rotates at least 45 degrees counter-clockwise or clockwise within the cavity of the base, and wherein the at least one protrusion is inserted into the valve to open the valve; donning the respirator; and performing the respirator fit test.

The present disclosure provides a kit including: an adapter for respirator fit testing, wherein the adapter comprises a base having a cavity; an apparatus comprising a platform connecting a first end to a second end, wherein the first end is configured to attach to an adapter of a respirator, wherein the adapter comprises a base having a cavity configured to receive the first end, wherein the second end comprises at least one protrusion extending from the platform, wherein the at least one protrusion comprises a length capable of extending into a valve in a respirator; and wherein the at least one protrusion is inserted into the valve to open the valve.

### DESCRIPTION OF THE DRAWINGS

It is to be understood that both the foregoing summary and the following drawings and detailed description may be exemplary and may not be restrictive of the aspects of the present disclosure as claimed. Certain details may be set forth to provide a better understanding of various features, aspects, and advantages of the invention. However, one skilled in the art will understand that these features, aspects, and advantages may be practiced without these details. In other instances, well-known structures, methods, and/or processes associated with methods of practicing the various features, aspects, and advantages may not be shown or described in detail to avoid unnecessarily obscuring descriptions of other details of the invention.

The present disclosure may be better understood by reference to the accompanying drawing sheets, in which:

FIG. 1 includes a valve prop apparatus in accordance with certain aspects of the presently disclosed invention described herein.

FIG. 2 includes a valve prop apparatus in accordance with certain aspects of the presently disclosed invention described herein.

FIG. 3 includes a base capable of receiving a valve prop apparatus in accordance with certain aspects of the presently disclosed invention described herein.

FIG. 4 includes a valve prop apparatus inserted into a base in accordance with certain aspects of the presently disclosed invention described herein.

FIG. 5 includes an adapter for a respirator having a base in accordance with certain aspects of the presently disclosed invention described herein.

FIG. 6 includes an adapter with a valve prop apparatus inserted into a base in accordance with certain aspects of the presently disclosed invention described herein.

FIG. 7A includes a converter having a base in accordance with certain aspects of the presently disclosed invention described herein.

FIG. 7B includes a converter having a valve prop apparatus inserted into a base in accordance with certain aspects of the presently disclosed invention described herein.

FIG. 8 includes a converter having a valve prop apparatus inserted into a base, wherein the dashed lines indicate any adapter for a respirator capable of removably attaching to the converter.

FIG. 9 includes a valve prop apparatus having protrusions of different lengths in accordance with certain aspects of the presently disclosed invention described herein.

FIG. 10 includes a valve prop apparatus in accordance with certain aspects of the presently disclosed invention described herein.

FIG. 11 includes an adapter with a valve prop apparatus inserted into a base in accordance with certain aspects of the presently disclosed invention described herein.

FIG. 12A includes a valve prop apparatus in accordance with certain aspects of the presently disclosure invention described herein.

FIG. 12B includes a valve prop apparatus in accordance with certain aspects of the presently disclosure invention described herein.

FIG. 12C includes a valve prop apparatus in accordance with certain aspects of the D

FIG. 12D includes a valve prop apparatus in accordance with certain aspects of the presently disclosure invention described herein.

### DETAILED DESCRIPTION

This disclosure generally describes a valve prop apparatus for opening a valve of a respirator for respirator fit testing. The disclosure further provides methods for opening a valve of a respirator for respirator fit test using a valve prop apparatus of the present disclosure. The present disclosure provides kits including a valve prop apparatus, an adapter for a respirator, and/or a converter capable of attaching to an adapter, wherein the converter includes a valve prop apparatus.

It is understood, however, that this disclosure also embraces numerous alternative features, aspects, and advantages that may be accomplished by combining any of the various features, aspects, and/or advantages described herein in any combination or sub-combination that one of ordinary skill in the art may find useful. Such combinations or sub-combinations are intended to be included within the scope of this disclosure. As such, the claims may be amended to recite any features, aspects, and advantages expressly or inherently described in, or otherwise expressly or inherently supported by this disclosure. Further, any features, aspects, and advantages that may be present in the prior art may be affirmatively disclaimed. Accordingly, this disclosure may comprise, consist of, consist essentially of, or be characterized by one or more of the features, aspects, and advantages described herein.

### Definitions

Unless otherwise defined, all terms (including technical and scientific terms) used herein have the same meaning as commonly understood by one of ordinary skill in the art to which this disclosure belongs. As such, terms, such as those defined by commonly used dictionaries, should be interpreted as having a meaning that is consistent with their meaning in a context of a relevant art and should not be interpreted in an idealized or overly formal sense unless expressly so defined herein.

As used herein, the term “Controlled Negative Pressure” or “CNP” refers to a quantitative fit testing method utilizing negative pressure as a direct measure of respirator leakage using air as the test challenge agent. CNP is based on exhausting air from a temporarily sealed respirator facepiece to generate and then maintain a constant negative pressure inside the facepiece, wherein the rate of air exhaust is controlled such that a constant negative pressure is maintained in the respirator during the fit test. With constant pressure, air flow out of the respirator is equal to air flow into the respirator.

As used herein, the term “adapter” may be used to refer to any device capable of attaching and/or connecting a respirator to a fit testing device.

As used herein, the term “valve” may be used to refer to any valve of a respirator, including, but not limited to, a butterfly-type popper valve, an exhalation valve, a diaphragm-type valve, a controlled air valve, an inhalation valve, and the like. A valve may include one or more partitions or spokes extending radially from a central axis of the valve.

As used herein, the term “respirator” refers to, but is not limited to, a tight-fitting respirator, an air-purifying respirator, a supplied-air respirator, an elastomeric half facepiece respirator, an elastomeric full facepiece respirator, a filtering facepiece respirator, a powered air-purifying respirator, a supplied-air respirator, a self-contained breathing apparatus, or a combination respirator.

U.S. Pat. No. 8,528,559 entitled “RESPIRATOR FIT-TESTING APPARATUS AND METHOD” and U.S. Pat. No. 8,011,368 entitled “RESPIRATOR FIT-TESTING APPARATUS AND METHOD” are hereby incorporated by reference in their entirety.

As used herein, the term “and/or” includes any and all combinations of one or more of the associated listed items. Likewise, as used in the following detailed description, the term “or” is intended to mean an inclusive “or” rather than an exclusive “or.” That is, unless specified otherwise, or clear from context, “X employs A or B” is intended to mean nay of the natural inclusive permutations. Thus, if X employs A; X employs B; or X employs both A and B, then “X employs A or B” is satisfied under any of the foregoing instances.

The terminology used herein is for the purpose of describing particular examples only and is not intended to be limiting. As used herein, the singular forms “a,” “an,” and “the” may be intended to include the plural forms as well, unless the context clearly dictates otherwise. As example, “a” valve may comprise one or more valves, and the like.

The terms “comprises,” “comprising,” “including.” “having,” and “characterized by,” may be inclusive and therefore specify the presence of stated features, elements, compositions, steps, integers, operations, and/or components, but do not preclude the presence or addition of one or more other features, integers, steps, operations, elements, components, and/or groups thereof. Although these open-ended terms may be to be understood as a non-restrictive term used to describe and claim various aspects set forth herein, in certain aspects, the term may alternatively be understood to instead be a more limiting and restrictive term, such as “consisting of” or “consisting essentially of.” Thus, for any given aspect reciting compositions, materials, components, elements, features, integers, operations, and/or process steps, described herein also specifically includes aspects consisting of, or consisting essentially of, such recited compositions, materials, components, elements, features, integers, operations, and/or process steps. In the case of “consisting of”, the alternative aspect excludes any additional compositions, materials, components, elements, features, integers, operations, and/or process steps, while in the case of “consisting essentially of”, any additional compositions, materials, components, elements, features, integers, operations, and/or process steps that materially affect the basic and novel characteristics may be excluded from such an aspect, but any compositions, materials, components, elements, features, integers, operations, and/or process steps that do not materially affect the basic and novel characteristics may be included in the aspect.

Any method steps, processes, and operations described herein may not be construed as necessarily requiring their performance in the particular order discussed or illustrated, unless specifically identified as an order of performance. It is also understood that additional or alternative steps may be employed, unless otherwise indicated.

In addition, features described with respect to certain example aspects may be combined in or with various other example aspects in any permutational or combinatory manner. Different aspects or elements of example aspects, as disclosed herein, may be combined in a similar manner. The term “combination,” “combinatory,” or “combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included may be combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Words such as “then,” “next,” etc. are not intended to limit the order of the steps; these words may be simply used to guide the reader through the description of the methods.

In the description, certain details are set forth to provide a better understanding of various aspects of the systems and methods disclosed herein. However, one skilled in the art will understand that these aspects may be practiced without these details and/or in the absence of any details not described herein. In other instances, well-known structures, methods, and/or techniques associated with methods of practicing the various aspects may not be shown or described in detail to avoid unnecessarily obscuring descriptions of other details of the various aspects.

While specific aspects of the disclosure have been provided hereinabove, the disclosure may, however, be embodied in many different forms and should not be construed as necessarily being limited to only the aspects disclosed herein. Rather, these aspects may be provided so that this disclosure is thorough and complete, and fully conveys various concepts of this disclosure to skilled artisans.

Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.”

All numerical quantities stated herein may be approximate, unless stated otherwise. Accordingly, the term “about” may be inferred when not expressly stated. The numerical quantities disclosed herein may be to be understood as not being strictly limited to the exact numerical values recited. Instead, unless stated otherwise, each numerical value stated herein is intended to mean both the recited value and a functionally equivalent range surrounding that value. At the very least, and not as an attempt to limit the application of the doctrine of equivalents to the scope of the claims, each numerical value should at least be construed in light of the number of reported significant digits and by applying ordinary rounding processes. Typical exemplary degrees of error may be within 20%, 10%, or 5% of a given value or range of values. Alternatively, the term “about” refers to values within an order of magnitude, potentially within 5-fold or 2-fold of a given value. Notwithstanding the approximations of numerical quantities stated herein, the numerical quantities described in specific examples of actual measured values may be reported as precisely as possible. Any numerical values, however, inherently contain certain errors necessarily resulting from the standard deviation found in their respective testing measurements.

All numerical ranges stated herein include all sub-ranges subsumed therein. For example, a range of “1 to 10” or “1-10” is intended to include all sub-ranges between and including the recited minimum value of 1 and the recited maximum value of 10 because the disclosed numerical ranges may be continuous and include every value between the minimum and maximum values. Any maximum numerical limitation recited herein is intended to include all lower numerical limitations. Any minimum numerical limitation recited herein is intended to include all higher numerical limitations.

Features or functionality described with respect to certain example aspects may be combined and sub-combined in and/or with various other example aspects. Also, different aspects and/or elements of example aspects, as disclosed herein, may be combined and sub-combined in a similar manner as well. Further, some example aspects, whether individually and/or collectively, may be components of a larger system, wherein other procedures may take precedence over and/or otherwise modify their application. Additionally, a number of steps may be required before, after, and/or concurrently with example aspects, as disclosed herein. Note that any and/or all methods and/or processes, at least as disclosed herein, may be at least partially performed via at least one entity or actor in any manner.

All documents cited herein may be incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art with respect to this application.

While particular aspects have been illustrated and described, it would be obvious to those skilled in the art that various other changes and modifications may be made without departing from the spirit and scope of the invention. Those skilled in the art will recognize or be able to ascertain using no more than routine experimentation, numerous equivalents to the specific apparatuses and methods described herein, including alternatives, variants, additions, deletions, modifications, and substitutions. This application including the appended claims is therefore intended to cover all such changes and modifications that may be within the scope of this application.

### DESCRIPTION

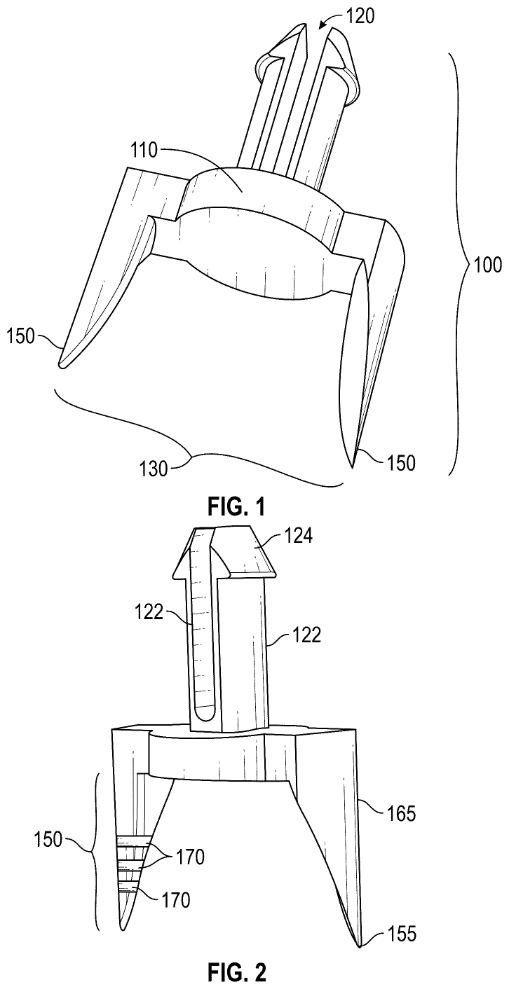

The present disclosure provides an apparatus for opening a valve of a respirator for respirator fit testing. The apparatus 100 may include a platform 110 connecting a first end 120 to a second end 130 (FIG. 1).

The first end 120 may be configured to attach to an adapter and/or converter for a respirator. The first end 120 may removably attach to a base 140 of an adapter (FIGS. 3 & 11). The adapter may include a base 140 having a cavity 145 capable of receiving the first end 120 of the apparatus 100 (FIG. 3).

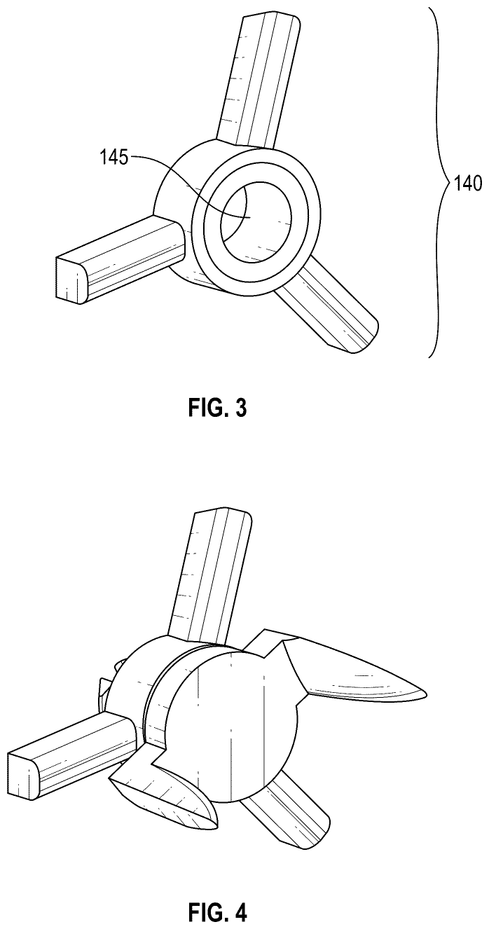

The first end 120 may include a snap fit joint having at least one cantilever arm 122 having an interlocking feature 124 (FIG. 2). The cavity 145 may be configured to receive the at least one cantilever arm 122. Upon entering the cavity 145, the at least one cantilever arm 122 may be deformed, e.g., forced radially inward toward the longitudinal axis of the first end. The interlocking feature may be configured to snap into place and return the at least one cantilever arm 122 to its original shape after insertion in the cavity 145. i.e., after the interlocking feature passes through the cavity After insertion in the cavity 145, the interlocking feature 124 may be in an engaged position (FIG. 4).

The apparatus 100 may be removed by applying pressure to the interlocking feature 124 of the at least one cantilever arm 122 in the engaged position to deform the at least one cantilever arm 122 radially inward so that the interlocking feature fits into the cavity 145. The apparatus 100 may then be removed from the cavity of the adapter and the at least one cantilever arm 122 may return to its original shape after removal of the apparatus 100 from the cavity 145 of the apparatus.

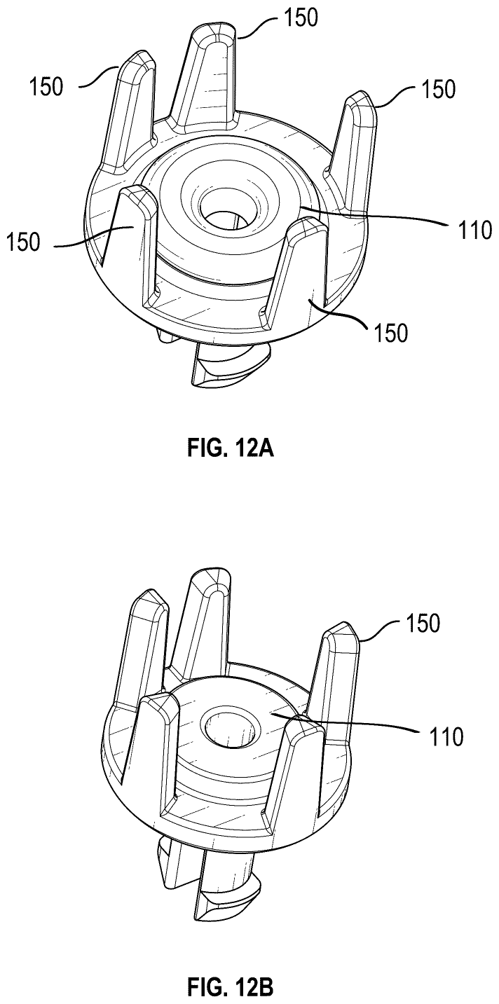

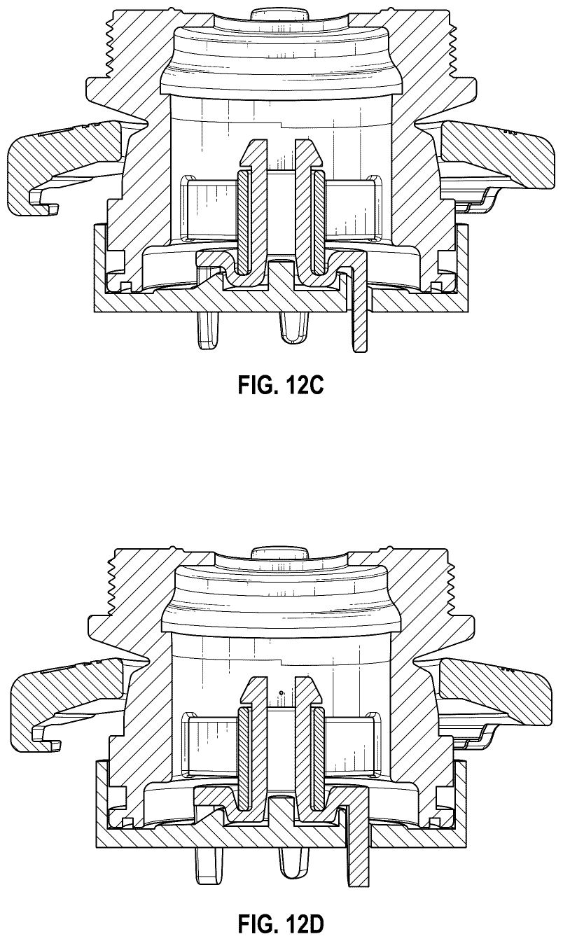

The second end 130 of the platform 110 may include at least one protrusion 150, including without limitation, at least 1, 2, 3, 4, 5, 6, 7, 8, 9, and at least 10 protrusions 150. The number of protrusions 150 may be dependent on the type of adapter and/or type of respirator. The number of protrusions 150 may be dependent on the type of valve to be opened. Thus, the apparatus 100 may include a first protrusion, a second protrusion, a third protrusion, a fourth protrusion, and the like. As a non-limiting example, the valve prop apparatus of the present disclosure may include five protrusions (FIGS. 12A & B). The protrusions of the valve prop apparatus need not be uniformly spaced from one another, as the protrusions may be different distances from each to increase the likelihood of the valve prop apparatus fitting into the valve housing cross sections of a respirator (see FIGS. 12A & 12B).

The at least one protrusion 150 may include a point 155, wherein the point 155 may penetrate a valve to open the valve (FIG. 2). The point 155 may be any shape or configuration capable of penetrating a valve of a respirator, including, but not limited to, ball-point or rounded, sharp, any combination thereof, or the like. The shaft 165 of the at least one protrusion may be of any shape or configuration capable of forming a tip capable of penetrating a valve of a respirator.

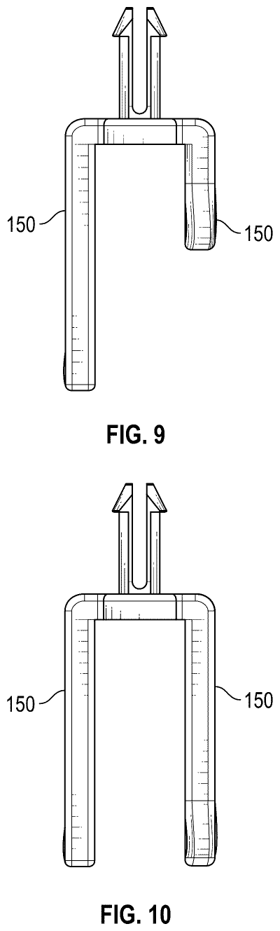

The apparatus 100 may include protrusions 150 of different lengths. As a non-limiting example, the first protrusion may include a length different than the second protrusion (FIG. 9). The apparatus 100 may include protrusions 150 having the same length. (FIGS. 1, 2 & 10))

The at least one protrusion 150 may include a length of 1 mm to 50 mm. The at least one protrusion 150 may include any length capable of penetrating the valve of a respirator to open the valve. The at least one protrusion may include a length of at least 1 mm, including but not limited to at least 1 mm, 2 mm, 5 mm, 10 mm, 15 mm, 20 mm, 25 mm, 30 mm, 35 mm, 40 mm, 45 mm, and at least 50 mm. The at least one protrusion may include a length of no more than 50 mm, including but not limited to 45 mm, 40 mm, 35 mm, 30 mm, 25 mm, 20 mm, 15 mm, 10 mm, 5 mm, 2 mm, and 1 mm. Any combination of lower and upper limits is possible, including, but not limited to, 1 mm to 5 mm, 1 mm to 10 mm, 1 mm to 15 mm, 1 mm to 20 mm, 1 mm to 25 mm, 1 mm to 30 mm, 1 mm to 40 mm, 1 mm to 50 mm, 1 mm to 5 mm, 5 mm to 10 mm, 10 mm to 15 mm, 15 mm to 20 mm, 20 mm to 25 mm, 25 mm to 30 mm, 30 mm to 35 mm, 35 mm to 40 mm, 40 mm to 45 mm, and 45 mm to 50 mm.

The at least one protrusion 150 may include at least one notch 170 (FIG. 2). The at least one notch 170 may include any marking or indication on the at least one protrusion 150 wherein a user may use the notch to cut or trim the at least one protrusion 150 to the desired length. The distance from each notch 170 may be a uniform distance such as every 5 mm, or the distance from each notch 170 may correspond to the appropriate length for a specific type and/or brand of respirator.

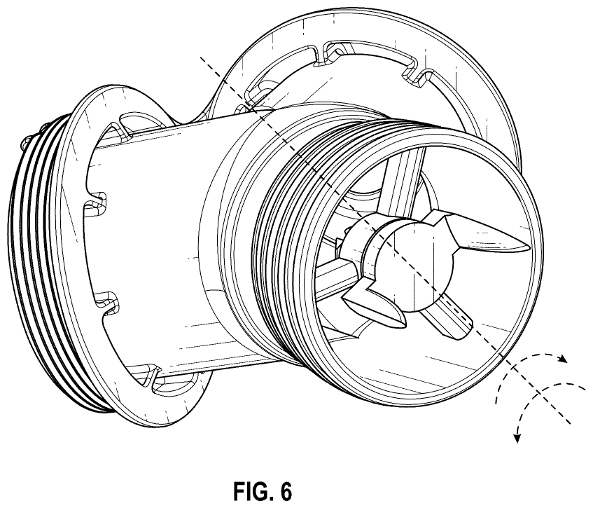

The platform 110 may be of any shape, circumference, or length capable of allowing the apparatus 100 to rotate axially with respect to a longitudinal axis (see dashed line of FIG. 6) of an adapter 300 for a respirator until the at least one protrusion 150 engages a valve of a respirator. The platform 110 may be of any shape, circumference, or length capable of allowing the apparatus 100 to rotate at least 45 degrees clockwise or counterclockwise with respect to the valve of a respirator. When the first end 120 of the apparatus 100 is in an engaged position within the cavity 145, the apparatus 100 may be capable of rotating clockwise or counterclockwise until the at least one protrusion 150 engages the valve to open the valve.

In some aspects, the platform 110 may include a flat, concave, or convex shape (see FIGS. 12A-12D) to allow the valve prop apparatus to recess into the valve structure.

The apparatus 100 may rotate clockwise or counterclockwise until the at least one protrusion engages the valve and the shaft 165 or point 155 of the apparatus 100 contacts one or more partitions or spokes extending radially from a central axis of the valve. The contact of the at least one protrusion and the one or more partitions or spokes places the valve in an engaged position, i.e., open.

The base 140 of the present disclosure may be of any shape, cavity circumference, depth, or length capable of allowing the apparatus 100 to rotate clockwise or counterclockwise until the at least one protrusion 150 engages the valve to open the valve. While a cylindrical base having a cavity 145 is shown in FIG. 3, other shapes, and sizes of bases 140 are possible and within the scope of the present disclosure.

The apparatus 100 may rotate at least 45 degrees, including without limitation, at least 45, 90, 120, 150, 180, 210, 240, 270, 300, 330, and at least 360 degrees. Any combination of lower and upper limits may define the rotation of the apparatus 100, such as, 45-360, or 45-300, 60-240, 45-90, 90-120, 120-150, 150-180, 180-210, 210-240, 240-270, 270-300, 300-330, and 330-360 degrees. The degree of rotation may depend on the size, shape, and/or type of adapter, respirator, and/or valve. The degree of rotation may depend on the size or number of partitions or spokes of the valve. The degree of rotation may further depend on the size, shape, and/or type of base 140 capable of receiving the apparatus. The apparatus 100 may perform at least 1 rotation, including, but not limited to at least 1, 2, 3, 4, 5, 6, 7, 8, 9, and at least 10 rotations.

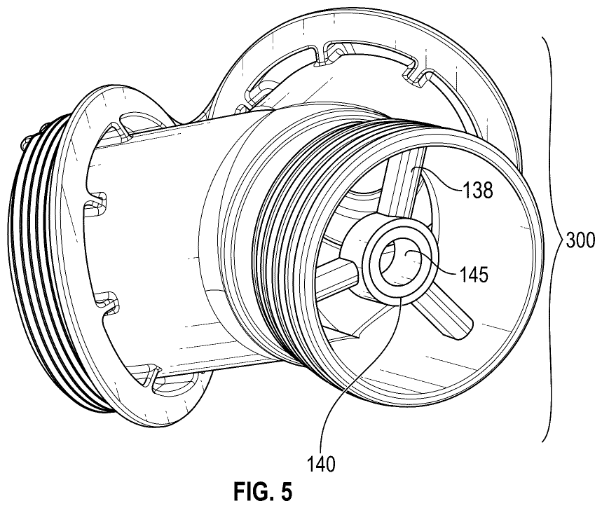

The present disclosure provides an adapter 300 for a respirator including a base 140 within the opening of the adapter, wherein the adapter may then be attached to the valve of the respirator. The base 140 may be attached to the adapter according to any method known in the art. As a non-limiting example, the base may be attached to the adapter via support columns 138 to hold the base 140 and cavity 145 in the opening of the adapter as shown in FIGS. 5 & 6. While a cavity 145 has been described, any attachment means of receiving the first end 120 of the apparatus 100 known in the art is possible and within the scope of the present disclosure.

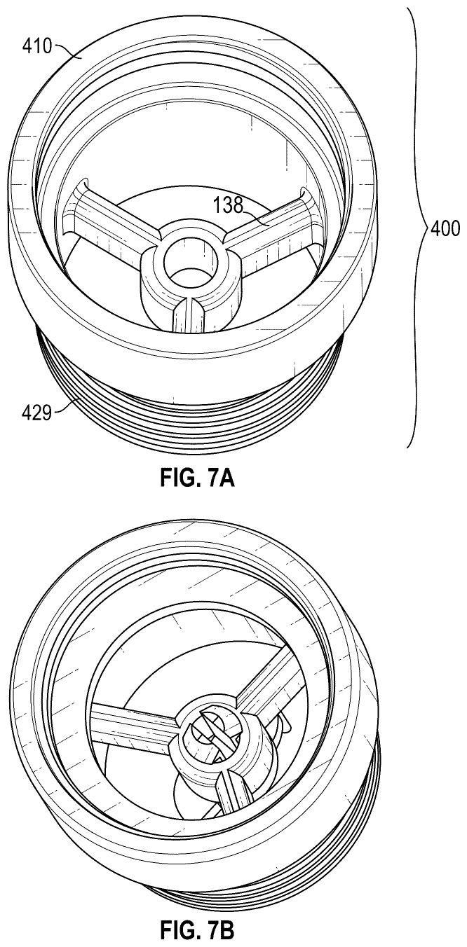

The present disclosure provides a converter 400 for an adapter 300 for a respirator (FIGS. 7A & 7B). The converter 400 may comprise a base 140 according to the present disclosure, wherein the first end 120 of the valve prop apparatus 100 may rotate according to the present disclosure. The converter may include a base 140 within an opening of the converter that may attached to the valve of the respirator. The base 140 may be attached to the converter according to any method known in the art. As a non-limiting example, the base may be attached to the converter via support columns 138 to hold the base 140 and cavity 145 in the opening of the converter as shown in FIGS. 7A & 7B.

The converter 400 of the present disclosure may removably attach to an adapter 300 for a respirator. As used herein, a “female thread” refers to at least one groove on the inside of converter or adapter. As used herein, a “male thread” refers to at least one groove externally placed on a converter or adapter.

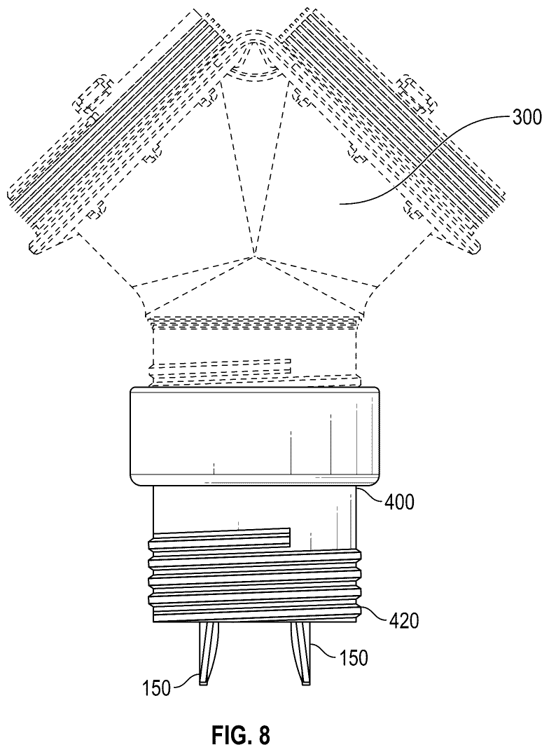

The converter 400 may include a first converter end 410 and a second converter end 420 (FIGS. 7A and 8). The first converter end 410 may include female threads capable of threadedly attaching to male threads on an opening of an adapter or male threads capable of threadedly attaching to female threads on an opening of an adapter (FIG. 8). While female and male threads are described, other means of attaching a converter to an adapter are possible and within the scope of the present disclosure.

The second converter end 420 may include the apparatus 100 and base 140 of the present disclosure (FIG. 7B). The second converter end 420 may include male threads capable of threadedly attaching to female threads of a respirator opening containing a valve so that the at least one protrusion 150 of the apparatus 100 is directed towards the valve of the respirator. The second converter end 420 may be screwed onto a respirator to removably attach the adapter having a converter to the respirator in order to open the valve according to the present disclosure. While male and female threads have been described, other means of connecting two pieces are possible and within the scope of the present disclosure.

A converter 400 having a base 140 and apparatus 100 of the present disclosure may be screwed or threadedly attached to an adapter known in the art for any respirator size or any respirator type. Accordingly, the present disclosure provides methods and devices for converting a prior art adapter to an adapter of the present disclosure by threadedly attaching the first end 410 of a converter 400 having an apparatus 100 and base 140 of the present disclosure to a prior art adapter.

The shape and dimensions of the converter 400 may depend on the type of respirator and/or type of adapter. One of ordinary skill in the art may readily determine the shape and dimensions of a converter for a particular respirator or adapter.

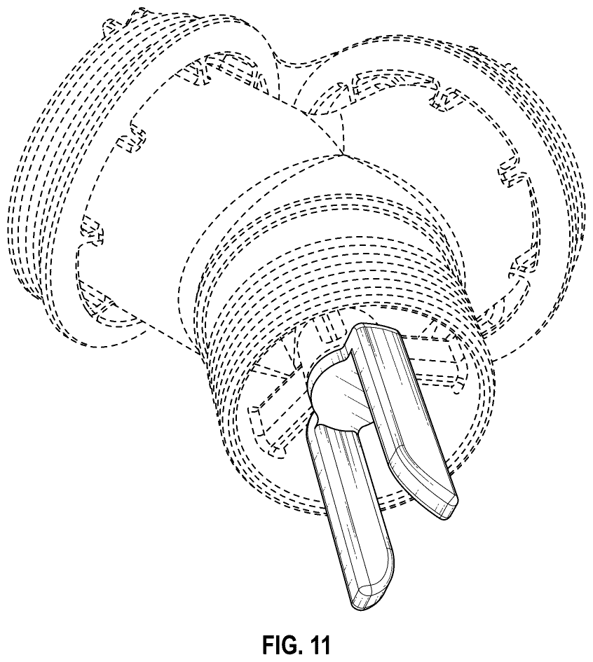

The present disclosure provides a method of opening a valve of a respirator for respirator fit testing. The method may include obtaining an adapter for respirator fit testing. The adapter may include an apparatus and base according to the present disclosure (FIG. 11). The adapter may include a converter having an apparatus and base according to the present disclosure.

The method may include threadedly attaching the adapter or adapter having a converter to the respirator, including causing the apparatus to rotate axially with respect to a longitudinal axis of the adapter or converter according to the present disclosure until the at least one protrusion engages the valve. The apparatus may rotate counterclockwise or clockwise within the cavity of the base until the at least one protrusion is inserted into the valve to engage the valve and hold the valve in an open position. The method may include donning or putting on the respirator and performing a respirator fit test. The method may include trimming the at least one protrusion according to at least one notch. Performing the fit test may include performing a controlled negative pressure fit test.

The apparatus 100 of the present disclosure rotates independently of the base, adapter, and converter. Once the apparatus opens the valve in the engaged position, the base, adapter, and converter are capable of continuing to rotate even after the valve is engaged until the adapter and/or converter including a base are threaded onto the respirator. The apparatus 100 remains engaged with the valve as the adapter and/or converter are threaded onto the adapter. The independent rotation of the apparatus 100 prevents destruction of the apparatus and/or the partitions or spokes of the valve. Conventional valve prop apparatuses may not rotate independently of the adapter, causing destruction of the apparatus or valve due to the pressure created from threading an adapter onto the respirator.

After the at least one protrusion engages the valve, the at least one protrusion of the apparatus may hold open the valve until the at least one protrusion is removed from the valve. Once a respirator fit test is completed, the method may include threadedly removing the adapter or adapter having a converter from the respirator, causing the at least one protrusion to disengage from the valve by rotating or threadedly removing in a direction necessary to disengage the at least one protrusion from the valve. The opening of the valve may be facilitated by the engagement of the at least one protrusion with the valve and does not require the platform or any other element of the apparatus to contact with the valve.

The at least one protrusion may locate at least one partition or spoke of the valve. As the adapter and/or adapter having a converter is threadedly attached, vertical downward threading pressure may automatically open the valve.

The apparatus of the present disclosure may open a valve of a respirator for the time necessary to set up and complete a respirator fit test. Thus, the apparatus may open a valve of a respirator as long as the adapter is threadedly attached to the respirator and engaging the at least one protrusion with the valve, including but not limited to, temporarily or permanently.

The present disclosure provides methods of manufacturing an apparatus of the present disclosure, a converter of the present disclosure, and an adapter of the present disclosure. Methods of manufacturing may include, but are not limited to, 3-Dimensional printing, laser printing, sintering, Computer Numerical Control (CNC) machining, and injection molding. Other manufacturing methods are possible and within the scope of the present disclosure.

The apparatus, converter, and/or adapter of the present disclosure may include any material or a combination of materials sufficient to provide adequate structural properties, including, but not limited to sufficient stiffness and deformability to perform the methods of the present disclosure. The material or combination of materials may include polylactic acid, acrylonitrile butadiene styrene, plastic, polyvinyl alcohol plastic, polycarbonate, alumide, polyamide, resin, high-detail resin, paintable resin, transparent resin, stainless steel, aluminum, bronze, nickel, titanium, carbon fiber, graphene, nitinol, paper, polyvinyl chloride, any combination thereof, and the like.

The present disclosure provides a kit including one or more of an adapter, an apparatus of the present disclosure, and/or a converter of the present disclosure. The kit may include a prior art adapter and/or an adapter of the present disclosure having a base.

Conventional valve prop apparatuses and methods of opening a valve of a respirator for respirator fit testing require manual assertion of an apparatus into the valve. Insertion may be difficult for a user who does not have specialized expertise with respirator fit testing and/or valves of a respirator. Thus, conventional apparatuses and methods may result in improper placement of the apparatus in the valve. Conventional apparatuses and methods may result in an increased likelihood for the apparatus to fall out and fail to hold open the valve. It is important during respirator fit testing to temporarily open a valve to ensure continuous air flow during a fit test. If a valve is not temporarily opened, the valve will close during testing, and the test will most likely fail or abort. Thus, conventional apparatuses and methods may result in an increased number of unnecessary failures of a respirator fit test.

With manual valve propping methods, the valve prop apparatus is often forgotten and left in by accident. When this occurs, the respirator does not function properly as the exhalation valve is open and becomes an inhalation source. This exposes the individual to unfiltered air, which may be dangerous or result in improper fit testing. The apparatus of the present disclosure eliminates these problems known in the art by ensuring removal of the valve prop apparatus.

Conventional methods of performing a fit test include removing the valve for respirator fit test. Removing the valve may disturb the fit of the respirator after a fit test is performed and the valve is replaced. Removing the valve from the respirator prior to performing a fit test may damage the valve.

Unlike conventional apparatuses and methods, the present disclosure enables a user without any prior experience to open a valve of a respirator in preparation for respirator fit testing using the apparatus and methods of the present disclosure. The engagement of the apparatus and valve when the adapter and/or converter are removably attached to the respirator enables the opening of the valve with minimal user interaction. Thus, a user of the apparatus and methods of the present disclosure is not required to touch the apparatus during insertion into the valve, as the valve is opened by removably attaching the adapter and/or converter having the apparatus to the respirator in order to engage the at least one protrusion with the valve. The apparatus, adapter, converter, and methods of the present disclosure provide an improved mechanism of action, which may solve one or more of the shortcomings in the art. The apparatus, adapter, converter, and methods of the present disclosure may eliminate any potential interference with the respirator's valve architecture.

Since the apparatus may rotate freely counterclockwise or clockwise within the cavity of the base until the at least one protrusion is engaged with a partition or spoke of the valve, the present disclosure enables the apparatus to rotate until the at least one protrusion is engaged with the valve. Once in an engaged position, the apparatus may not rotate counterclockwise or clockwise within the cavity of the base as the adapter and/or converter are threadedly attached to the respirator. As the adapter and/or converter are threadedly removed from the respirator, the apparatus may disengage the valve and rotate counterclockwise or clockwise so the protrusion is not in contact with the partition or spoke of the valve, allowing the apparatus to disengage and remove from the valve.

The present disclosure prevents the apparatus from inadvertently falling from or inadvertently being removed from the valve during set up and performance of a respirator fit test. The present disclosure prevents improper placement of the apparatus, as the base is positioned at the appropriate depth and diameter from the center of the adapter or converter opening having the base. Thus, once the apparatus is removably attached within the base according to the present disclosure, the apparatus is at the appropriate distance and location to ensure that the at least one protrusion is capable of engaging the valve to hold the valve in an open position. Thus, the adapter and/or converter may include the apparatus to ensure an integrated method to open the valve at the same time that the adapter and/or converter is attached to the respirator. The action of removably attaching the adapter or adapter having a converter to the respirator and the action of the apparatus rotating to open the valve until reaching an engaged position may occur independently and simultaneously.

Since different sizes, brands, manufacturers, and/or types of respirators may have different attachments, different adapters, different valves, or valves of different sizes, conventional valve prop apparatuses may not function in different respirators. The at least one notch of the present disclosure allows the valve prop apparatus of the present disclosure to function properly in respirators of difference sizes, brands, and/or types, as a user is able to trim or cut the at least one protrusion to ensure the at least one protrusion is the appropriate length to open the valve in an engaged position. Further, the length of the at least one protrusion, the size of the apparatus, the size of the base, the size and shape of the cavity, the size and shape of the adapter, and the size and shape of the converter may be altered in order to fit a specific respirator.

### Aspects

Aspect 1: An apparatus for opening a valve of a respirator for respirator fit testing, comprising: a platform connecting a first end to a second end; wherein the first end is configured to attach to an adapter of a respirator, wherein the adapter comprises a base having a cavity configured to receive the first end; wherein the second end comprises at least one protrusion extending from the platform; wherein the at least one protrusion comprises a length capable of extending into a valve in a respirator; and wherein the at least one protrusion is inserted into the valve to open the valve.
Aspect 2: The apparatus according to any of the foregoing aspects, wherein the at least one protrusion comprises at least one notch.
Aspect 3: The apparatus according to any of the foregoing aspects, wherein the at least one protrusion comprises a first protrusion and a second protrusion.
Aspect 4: The apparatus according to any of the foregoing aspects, wherein the first protrusion comprises a length different than the second protrusion.
Aspect 5: The apparatus according to any of the foregoing aspects, wherein the first protrusion and the second protrusion comprise the same length.
Aspect 6: The apparatus according to any of the foregoing aspects, wherein the first end comprises a snap fit joint comprising at least one cantilever arm having an interlocking feature, wherein the cavity is configured to receive the at least one cantilever arm, wherein the at least one cantilever arm is deformed upon entering the cavity, wherein the interlocking feature is configured to snap into place and return the at least one cantilever arm to its original shape after insertion in the cavity, and wherein the at least one cantilever arm is in an engaged position after insertion in the cavity.
Aspect 7: The apparatus according to any of the foregoing aspects, wherein the apparatus rotates counterclockwise or clockwise within the base until the at least one protrusion contacts at least one partition of the valve, and wherein the contact forms an engaged position to open the valve.
Aspect 8: The apparatus according to any of the foregoing aspects, wherein the rotation of the apparatus is independent of the rotation of the adapter being threadedly attached to the respirator.
Aspect 9: The apparatus according to any of the foregoing aspects, wherein the adapter comprises a converter.
Aspect 10: A method of opening a valve of a respirator for respirator fit testing, the method comprising: obtaining an adapter for respirator fit testing, wherein the adapter comprises a base having a cavity; inserting an apparatus into the cavity of the base, wherein the apparatus comprises a platform having a first end and a second end, wherein the cavity is configured to receive the first end, wherein the second end comprises at least one protrusion extending from the platform, wherein the at least one protrusion comprises a length configured to extend into a valve in a respirator, wherein the first end comprises a snap fit joint comprising at least one cantilever arm having an interlocking feature, wherein the cavity is configured to receive the at least one cantilever arm, wherein the at least one cantilever arm is deformed upon entering the cavity, wherein the interlocking feature is configured to snap into place and return the at least one cantilever arm to its original shape after insertion in the cavity, and wherein the at least one cantilever arm is in an engaged position after insertion in the cavity; attaching the adapter to the respirator, wherein attaching the adapter to the respirator comprises applying a pressure, wherein the apparatus rotates counter-clockwise or clockwise within the cavity of the base until the at least one protrusion contacts at least one partition of the valve, and wherein the contact forms an engaged position to open the valve, and wherein the rotation of the apparatus is independent of the rotation of the adapter being attached; donning the respirator; and performing the respirator fit test.
Aspect 11: The method according to any of the foregoing aspects, wherein the at least one protrusion comprises at least one notch.
Aspect 12: The method according to any of the foregoing aspects, the method further comprising: trimming the at least one protrusion at the at least one notch.
Aspect 13: The method according to any of the foregoing aspects, wherein the at least one protrusion comprises a first protrusion and a second protrusion.
Aspect 14: The method according to any of the foregoing aspects, wherein the first protrusion comprises a length different than the second protrusion.
Aspect 15: The method according to any of the foregoing aspects, wherein the first protrusion and the second protrusion comprise the same length.
Aspect 16: The method according to any of the foregoing aspects, wherein the respirator fit test is controlled negative pressure.
Aspect 17: The method according to any of the foregoing aspects, wherein the respirator is selected from a group consisting of: a tight-fitting respirator, an air-purifying respirator, a supplied-air respirator, an elastomeric half facepiece respirator, an elastomeric full facepiece respirator, a filtering facepiece respirator, a powered air-purifying respirator, a supplied-air respirator, a self-contained breathing apparatus, and a combination respirator.
Aspect 18: The method according to any of the foregoing aspects, wherein the valve is selected from a group consisting of: a butterfly-type popper valve, an exhalation valve, a diaphragm-type valve, a controlled air valve and an inhalation valve.
Aspect 19: The method according to any of the foregoing aspects, wherein the adapter comprises a converter.
Aspect 20: A kit comprising: an adapter for respirator fit testing, wherein the adapter comprises a base having a cavity; an apparatus comprising a platform connecting a first end to a second end, wherein the first end is configured to attach to the base, wherein the second end comprises at least one protrusion extending from the platform, wherein the at least one protrusion comprises a length capable of extending into a valve in a respirator; and wherein the at least one protrusion is inserted into the valve to open the valve.
Aspect 21: A kit comprising: an adapter for respirator fit testing; a converter, wherein the converter comprises a base having a cavity, and wherein the converter threadedly attaches to the adapter; an apparatus comprising a platform connecting a first end to a second end, wherein the first end is configured to attach to the base, wherein the second end comprises at least one protrusion extending from the platform, wherein the at least one protrusion comprises a length capable of extending into a valve in a respirator; and wherein the at least one protrusion is inserted into the valve to open the valve.

What is claimed is:

1. An apparatus comprising:
a platform connecting a first end to a second end;
wherein the first end is configured to attach to an adapter of a respirator, wherein the adapter comprises a base having a cavity configured to receive the first end;
wherein the second end comprises at least one protrusion extending from the platform;
wherein the at least one protrusion comprises a length capable of extending into a valve in a respirator; and wherein the at least one protrusion is inserted into the valve to open the valve.

2. The apparatus of claim 1, wherein the at least one protrusion comprises at least one notch.

3. The apparatus of claim 1, wherein the at least one protrusion comprises a first protrusion and a second protrusion.

4. The apparatus of claim 3, wherein the first protrusion comprises a length different than the second protrusion.

5. The apparatus of claim 3, wherein the first protrusion and the second protrusion comprise the same length.

6. The apparatus of claim 1, wherein the first end comprises a snap fit joint comprising at least one cantilever arm having an interlocking feature, wherein the at least one cantilever arm is sized and shaped to deform upon entering the cavity, wherein the interlocking feature is configured to snap into place when engaged with the cavity and return the at least one cantilever arm to its original shape after insertion through the cavity.

7. The apparatus of claim 6, wherein the apparatus rotates counterclockwise or clockwise within the base until the at least one protrusion contacts at least one partition of the valve, and wherein the contact forms an engaged position to open the valve.

8. The apparatus of claim 1, wherein the rotation of the apparatus is independent of the rotation of the adapter being threadedly attached to the respirator.

9. The apparatus of claim 1, wherein the adapter comprises a converter, wherein the converter comprises the base having the cavity therein.

10. A method of opening a valve of a respirator for respirator fit testing, the method comprising:
inserting an apparatus into a cavity of a base of an adapter for respirator fit testing, wherein the apparatus comprises a platform having a first end and a second end, wherein the cavity is configured to receive the first end, wherein the second end comprises at least one protrusion extending from the platform, wherein the at least one protrusion comprises a length configured to extend into a valve in a respirator, wherein the first end comprises a snap fit joint comprising at least one cantilever arm having an interlocking feature, wherein the cavity is configured to receive the at least one cantilever arm, wherein the at least one cantilever arm is deformed upon entering the cavity, wherein the interlocking feature is configured to snap into place and return the at least one cantilever arm to its original shape after insertion in the cavity, and wherein the at least one cantilever arm is in an engaged position after insertion in the cavity;
attaching the adapter to the respirator, wherein attaching the adapter to the respirator comprises applying a pressure, wherein the apparatus rotates counter-clockwise or clockwise within the cavity of the base until the at least one protrusion contacts at least one partition of the valve, and wherein the contact forms an engaged position to open the valve, and wherein the rotation of the apparatus is independent of the rotation of the adapter being attached. The method of claim 10, wherein the at least one protrusion comprises at least one notch.

11. The method of claim 10, the method further comprising: trimming the at least one protrusion at the at least one notch.

12. The method of claim 10, wherein the at least one protrusion comprises a first protrusion and a second protrusion.

13. The method of claim 12, wherein the first protrusion comprises a length different than the second protrusion.

14. The method of claim 12, wherein the first protrusion and the second protrusion comprise the same length.

15. The method of claim 10, wherein the respirator fit test is controlled negative pressure.

16. The method of claim 10, wherein the respirator is selected from a group consisting of:
a tight-fitting respirator, an air-purifying respirator, a supplied-air respirator, an elastomeric half facepiece respirator, an elastomeric full facepiece respirator, a filtering facepiece respirator, a powered air-purifying respirator, a supplied-air respirator, a self-contained breathing apparatus, and a combination respirator.

17. The method of claim 10, wherein the valve is selected from a group consisting of: a butterfly-type popper valve, an exhalation valve, a diaphragm-type valve, a controlled air valve and an inhalation valve.

18. The method of claim 10, wherein the adapter comprises a converter.

19. A kit comprising:
an adapter for respirator fit testing, wherein the adapter comprises a base having a cavity;
an apparatus comprising a platform connecting a first end to a second end, wherein the first end is configured to attach to the base, wherein the second end comprises at least one protrusion extending from the platform, wherein the at least one protrusion comprises a length capable of extending into a valve in a respirator; and wherein the at least one protrusion is inserted into the valve to open the valve.

20. A kit comprising:
an adapter for respirator fit testing;
a converter, wherein the converter comprises a base having a cavity, and wherein the converter threadedly attaches to the adapter; and
the apparatus of claim 1.
